(19) United States
(12) Patent Application Publication
(10) Pub. No.: US 2005/0104732 A1
(43) Pub. Date: May 19, 2005

(54) Chip scale package for a transponder

(76) Inventors: Urs Furter, Noville (CH); Marc Bielmann, La Tour-de-Treme (CH)

Correspondence Address: NIXON & VANDERHYE, PC, 1100 N GLEBE ROAD, 8TH FLOOR, ARLINGTON, VA, 22201-4714, US

(21) Appl. No.: 10/497,661

(22) PCT Filed: Dec. 7, 2001
(86) PCT No.: PCT/CH01/00704

(51) Int. Cl. G08B 13/14

(52) U.S. Cl. 340/572.7; 340/572.8; 343/872; 29/600; 257/679

(57) ABSTRACT

The invention relates to a transponder device which comprises a chip (5) and an antenna (8), the chip (5) being connected to the antenna (8), the transponder is characterized by the fact that the chip (5) is packed with a protective and insulating layer (14) of at least 30 μm thick, the layer being at least arranged between the chip (5) and the antenna (8), the antenna (8) being connected to the chip (5) through said layer (14).

### FIELD OF THE INVENTION

The present invention relates to a transponder device comprising a chip, i.e. a silicone substrate including an integrated circuit (IC), and an antenna, the antenna being connected to the chip.

### STATE OF THE ART

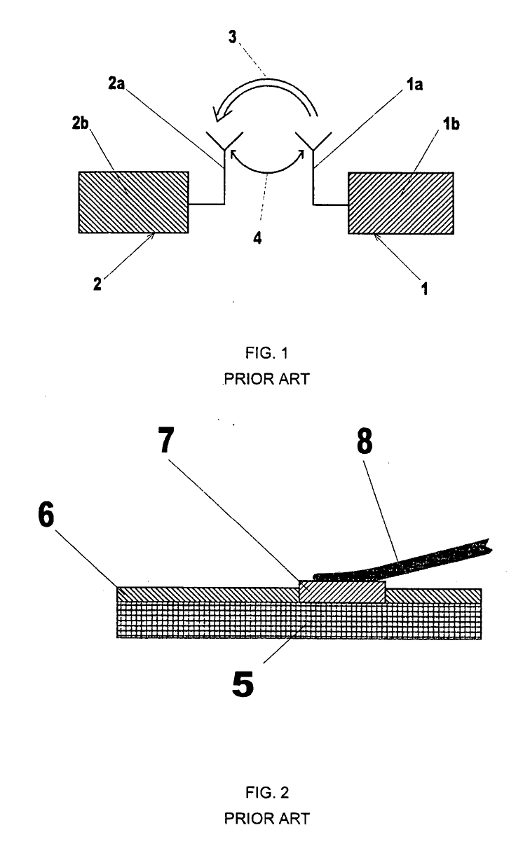

Transponders, in particular RFID transponders, are generally . used for identification purposes where wireless communication is needed. A passive RFID transponder 2 (see FIG. 1) is made by connecting an Application Specific Integrated Circuit (ASIC) 2b to an antenna circuit 2a. An external communication circuit 1, also called reader, supplies the transponder 2 with energy 3 as information 4 trough both antennas 1a, 2a. The supplied transponder 2 sends information 4 back to the reader using the same antenna system 1a, 2a.

The following methods for connecting the antenna to the chip are commonly used:

The chip 5 is designed to have large size conductive pads 7 on which the antenna wire 8 can be bonded (see FIG. 2).

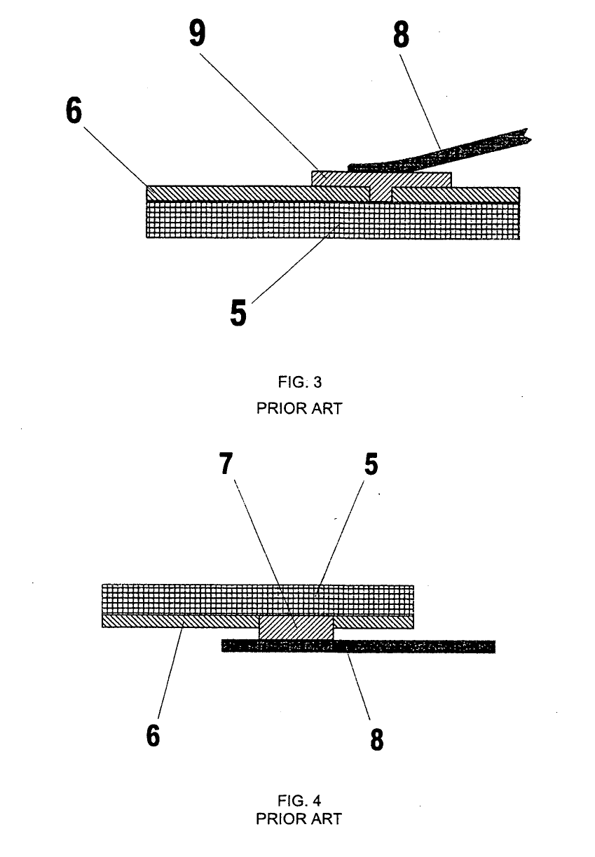

The chip which is protected by a passivation layer (typically of approx. 1 μm thick) is designed so that the small conductive pads 9 are enlarged and overlaying the electronic circuitry where only the passivation layer 6 serves as insulation layer. This known process is disclosed in WO 92/22827. (see FIG. 3).

The chip with small conductive pads and protected by a passivation layer is flipped on to the antenna extremities. This well known flip-chip process is commonly used in case of flat antennas as etched or printed coils. (see FIG. 4).

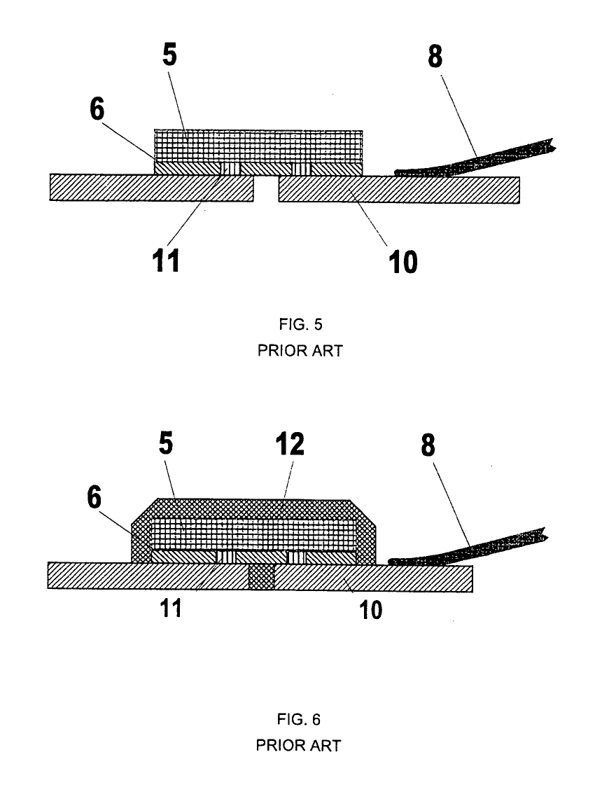

The chip 5 is mounted on a substrate 10 by using for example a solder ball 11 flip-chip technique as shown in FIG. 5 or wire bonding techniques. Enlarged interconnection areas are located on the substrate 10, thus allowing easy connection with the antenna 8.

The chip 5 is mounted on a substrate 10 by using for example a solder ball 11 flip-chip technique as shown in FIG. 6 or wire bonding techniques. Enlarged interconnection areas are located on the substrate 10, thus allowing easy connection with the antenna 8. The chip is then furthermore protected by an encapsulation layer 12, which can be manufactured by overmolding. This packaging is commonly called “module” as for example MOA2 module or MCC2 module.

With the ongoing technology integration on the chip, the known technologies for direct bonding as show in FIG. 2, FIG. 3 and FIG. 4, becomes critical. In case of using large conductive pads (FIG. 2), the therefore used surface is lost to integrate any circuitry. The size of the chip is proportional to its price, therefore such technology increases chip price and will no more be competitive.

The other direct connection method using overlaying conductive pads (FIG. 3) keeps the price advantage due to the fact that no major connection surface is lost. But the fine electronic structures, due to the high integration, becomes more sensitive to any applied mechanical and or thermal stress.

The bonding technology described in FIG. 4 is not applicable for all type of antennas, mainly for flat antennas as etched or printed coils.

Moreover, the high integrated circuits are much more sensitive to parasitic coupling effects induced through the antenna connections. There also, the passivation layer is not thick enough to avoid parasitic coupling effects which decreases considerably the transponder performances.

Technologies described in FIG. 2, 3 and 4 do not protect the chip against external factors such as mechanical stress issued at manufacturing of the transponder or its use later in the application.

Considering the actual packages described in FIG. 5 and FIG. 6, also called chip modules, they have the disadvantage to be large in size and costly. The large size does no more allow the manufacturing of very small transponders such as glass tubes of Ø2 mm×12 long used for pet identification.

### SUMMARY OF THE INVENTION

The purpose of the present invention aims at providing a transponder device for which the previous cited problems are avoided or at least strongly reduced.

It combines the advantages of a packed chip (high mechanical and thermal resistance and easy to handle), the advantage of direct connection (to be very small in size and cost effective) and the advantage to reduce all undesirable parasitic coupling.

It relates to a transponder device comprising a packed chip and an antenna, the package being connected to the antenna, characterized by the fact that the package is composed of a protective and insulating layer of at least 30 μm which is arranged between the chip and the antenna connections, the antenna connections being connected to the chip through the packaging using e.g. small pillar bumps.

It has indeed been observed that the presence of an insulating layer of at least 30 μm thick between the chip and the antenna considerably reduces the above cited parasitic coupling. Furthermore, such a thickness can be considered as a packaging and confers a protection for the chip against external factors such as environmental, thermal or mechanical stress.

30 μm constitute a lower limit for the layer thickness. Thicker layers may be used, e.g. of approx. 100 μm.

In the present text the term package means “at least partially coated on the chip active side”. The same applies for the terms pack, packed, packaging, etc. . .

The invention also relates to the addition of a surface metallisation on the package to increase the size of the conductive areas. By this way, the packed chip is particularly suitable to for a direct connection with the antenna. For example an enamelled copper wire forming the antenna can be direct connected to the packed chip while maintaining the smallest possible size.

The interconnection pads can be relocated anywhere on the external face of the packaging.

Other possibilities, to use the package surface as substrate for additional components mounting will allow to achieve the smallest possible dimensions.

For some high frequency application, the surface metallisation can be directly designed to be the antenna. This kind of products are also known as for example under “coil on chip”. Also if on the first structure, the same packaging method is repeated, it is possible to add an additional antenna structure which will allow to build up for example a multi-layer coil.

### DETAILED DESCRIPTION OF THE INVENTION

Some examples according to the invention will be hereafter described with the help of the following figures:

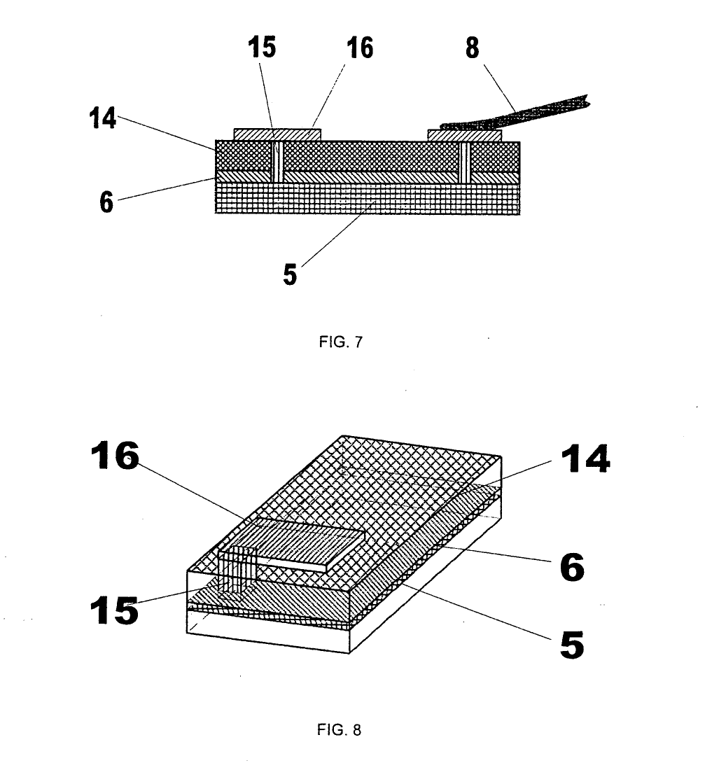

FIG. 7 shows a front view of a transponder chip scale package according to the invention.

FIG. 8 shows a three dimensional view of the transponder chip scale package illustrated on FIG. 7.

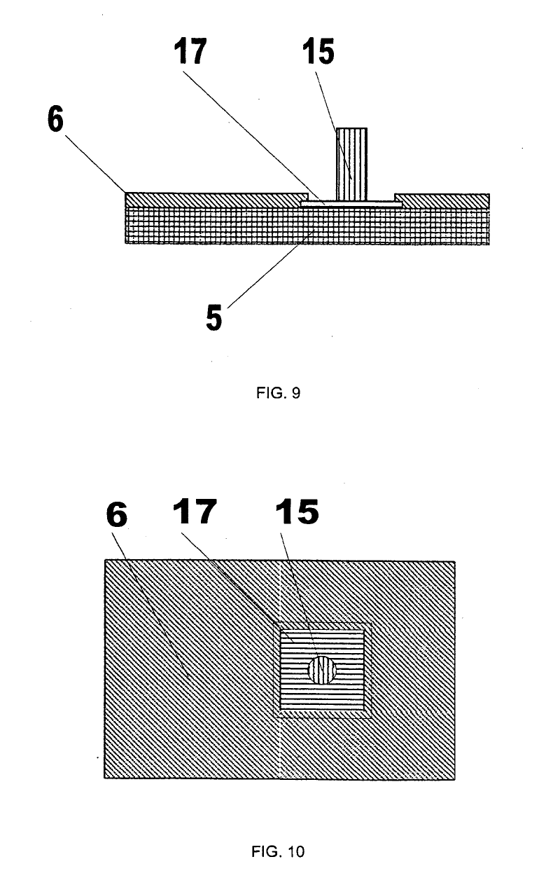

FIG. 9 shows the side view of the chip after manufacturing of the pillar bumps.

FIG. 10 shows the top view of the chip after manufacturing of the pillar bumps.

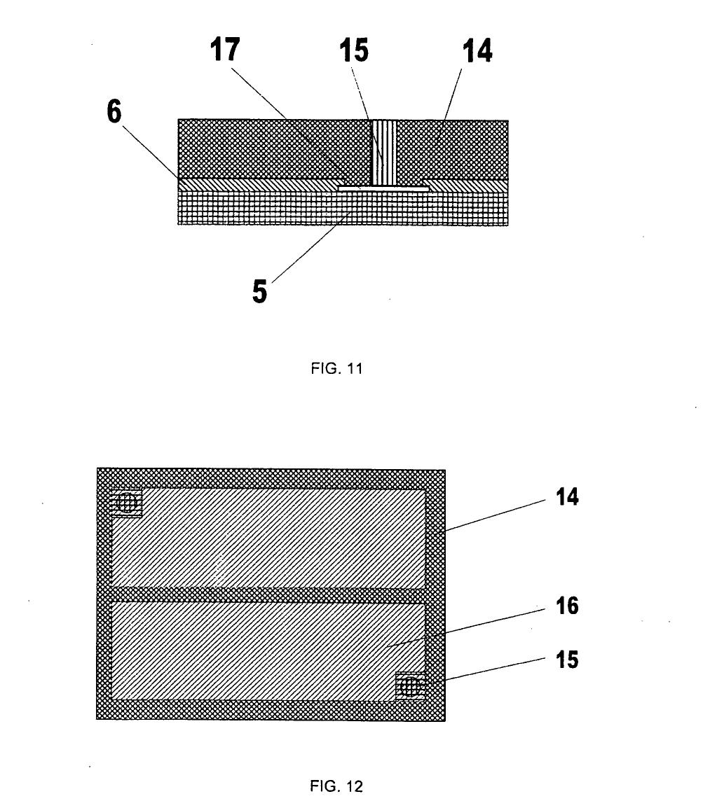

FIG. 11 shows the side view of the chip after the packaging process, the pillar bumps appearing on the package surface.

FIG. 12 shows the top view of the packed chip where the surface metallisation enlarges the pillar bump surface.

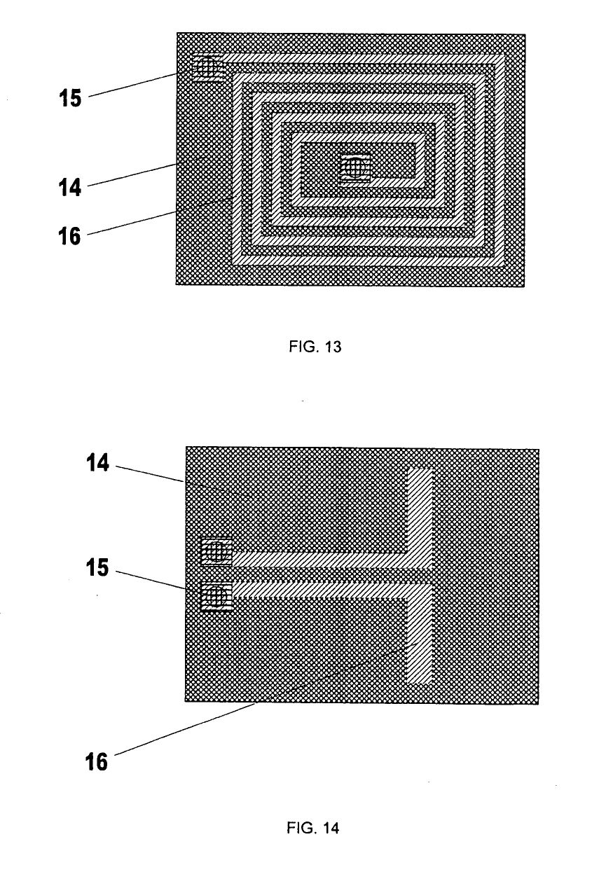

FIG. 13 shows the top view of the packed chip where the surface metallisation is designed to be a coil antenna.

FIG. 14 shows the top view of the packed chip where the surface metallisation is designed to be a high frequency antenna.

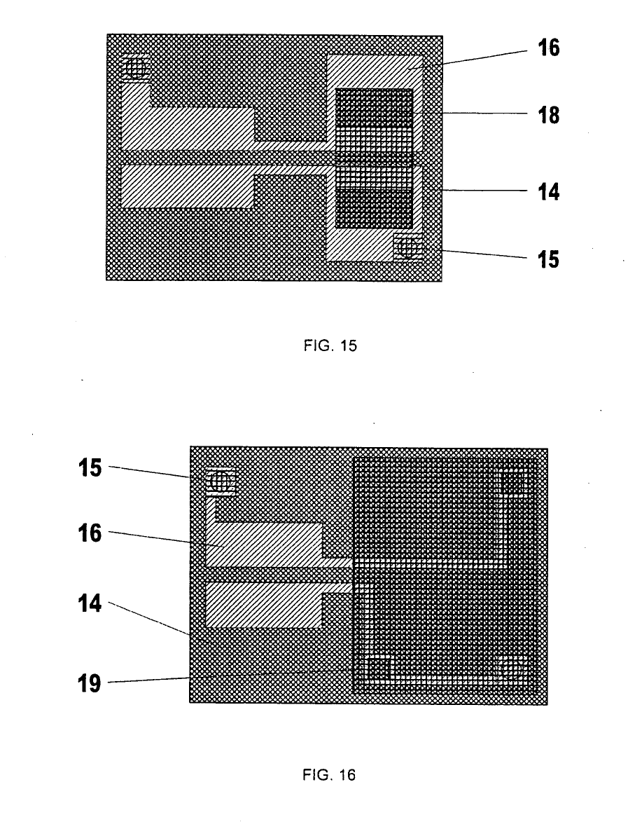

FIG. 15 shows the top view of the packed chip where the surface metallisation is designed so that an capacitor can be mounted.

FIG. 16 shows the top view of the packed chip where the surface metallisation is designed so that an additional chip can be mounted.

The transponder chip scale package illustrated on FIGS. 7 and 8 consists of a chip 5 on which a passivation layer 6 is arranged. A packaging process where the insulating and protective layer 14, preferably made of organic material such as epoxy, is deposed on the passivation layer 6.

The antenna 8 is connected to the chip 5 via two interconnection pads 16 and two connecting elements 15 which are crossing the insulating and protective or packaging layer 14. The surface of the interconnection pads 16 being larger than the section of the connecting elements 15. Those larger surfaces facilitate the connection between the interconnection pads 16 and the antenna 8.

The interconnection pads 16 can be relocated anywhere on the external face of the packaging 14.

FIGS. 9 and 10 show an example for manufacturing the connecting elements between the chip and the package surface. In the present case these elements can be named “conductive pillars bumps”, they have to be on one side connected to the chip metal pad 17. The pillar material has to be conductive the typical materials are copper (Cu) or gold (Au). The size is chosen so that the minimal stress is induced from package outside to the chip pad while processing the packed chip. The height of the pillar is adapted to the desired thickness of the package.

The packaging of the integrated circuit 5 is done by adding one (or more) insulation layer 14 over the surface of the integrated circuit. The chip or integrated circuit 5, is in general already protected at wafer manufacturing with a so called passivation layer 6 and in some cases with an additional polyimide layer. But not sufficient to be suitable for the direct connection of the antenna extremities and moreover, are not acting as packaging.

To keep the packaging size as small as possible, the integrated circuit encapsulation should be done on wafer level. By this way, the chip size is only increased in thickness.

FIG. 11 show the integrated circuit after deposition of the insulating layer 14 which can be done by stencil printing methods or by overmoulding.

The insulating material has to be chosen according to the encapsulation process as to match the thermal coefficients of the integrated circuit.

The insulating material may not fully covers the chip surface, this for example to let free a sensor areas located on the chip. The insulating layer may also cover other faces of the chip.

A metal layer 16 is then arranged on the top of the insulating layer 14. The conductive area 15 of the pillar bumps are very small and are too difficult to handle for connection with the antenna. The metal layer 16 is connected to the pillars bumps 15. The simplest possibility is to use the metallisation for arranging the chip connection where they are needed to optimise the assembly process.

The interconnection pads can be relocated anywhere on the external face of the insulating and protective layer.

One first possibility shown in FIG. 12, is to use the metallisation to enlarge the small conductive pillar bumps 15. By this way, large size wires, large conductive antenna extremities can be easy connected to the packed chip. Also using large size pads 16 on the package surface will simplify the interconnection process in-between the antenna and the packed chip, higher yield and faster process are the main improvements. For example an enamelled copper wire forming the antenna can be easily connected to the packed chip with the important advantage keeping the smallest possible size.

A second possibility shown in FIG. 13 and FIG. 14 is to use the packed surface 14 as substrate on which the metallisation 16 is designed to be the needed antenna. For some RFID chips packed as previously explained, the metallisation can be the coil.

A third possibility shown in FIG. 15 & 16, is to use the packed surface as substrate on which the metallisation 16 is designed for mounting additional component such as a capacitor 18 or a chip 19.

It can be for example possible to pack the chip capacitor by the described method and design the package metallisation for chip and antenna connection. By this way the RFID chip can be reduced in size due to the fact that the resonance or supply capacitor is no more needed.

An other example is to add a sensor chip on the packed RFID chip. By this way additional functionalities can be obtained allowing then that the RFID chip encloses a simple communication port which allow to connect any sensor chip on request.

1. Transponder device comprising a chip (5) and an antenna (8), the chip (5) being connected to the antenna (8), characterized by the fact that the chip (5) is packed with a protective and insulating layer (14) of at least 30 μm thick, said layer being at least arranged between the chip (5) and the antenna (8), the antenna (8) being connected to the chip (5) through said layer (14).

2. Transponder device according to claim 1 wherein connecting means (15) are connecting the chip (5) to the antenna (8), said connecting means (15) being arranged in said layer (14) and being enlarged on the package surface or antenna side of said layer (14) in order to facilitate the connection between the antenna (8) and the connecting means (15).

3. Transponder device according to claim 2 wherein said connecting means (15) are enlarged on the package surface or on the antenna side of said layer (14) in such a way that they constitute the antenna.

4. Transponder device according to claim 3 wherein said connecting means (15) are enlarged on the package surface or on the antenna side of said layer (14) in such a way that they constitute a surface for mounting additional electronics such as capacitor or chips.

5. Transponder device according to claim 1 wherein said layer (14) is made of organic material such as epoxy.

6. Transponder device according to claim 1 wherein the chip is packed by a plurality of protective and insulating layers arranged at least between the chip (5) and the antenna (8), the antenna (8) being connected to the chip (5) through said layers (14) by a plurality of connecting means (15).
